(19) United States
(12) Patent Application Publication
(10) Pub. No.: US 2006/0042883 A1
(43) Pub. Date: Mar. 2, 2006

(54) Elevator pit safety device

(76) Inventor: Gary Scott, Stewiacke (CA)

Correspondence Address: NIXON & VANDERHYE, PC, 901 NORTH GLEBE ROAD, 11TH FLOOR, ARLINGTON, VA, 22203, US

(21) Appl. No.: 10/932,236

(22) Filed: Sep. 2, 2004

(51) Int. Cl. B66B 5/28

(52) U.S. Cl. 187/351

(57) ABSTRACT

The present invention relates to an improved safety device for elevator or lift maintenance and service. The safety device of the present invention can be used in any vertical transportation shaft to provide protection to individuals in the pit of an elevator. The safety device consists of a shoring means which is connected to the vertical side surface of the vertical transportation shaft via mounting means, which allow the shoring means to be moved from a retracted position, wherein the shoring means is disposed in the vicinity of the vertical side surface, to a deployed position, wherein the shoring means is disposed vertically and spaced from the side vertical surface. In the deployed position, the shoring means provides a physical barrier between the elevator car and the floor of the vertical transportation shaft, thus preventing potential injury to the serviceperson working in the pit.

### FIELD OF INVENTION

The present invention relates, generally, to an improved safety device for elevator or lift maintenance and service. More specifically, the invention relates to a shoring device that can be deployed in an elevator pit or hoistway to prevent an elevator or elevator car from trapping or crushing a serviceperson who is working in the pit.

### BACKGROUND OF THE INVENTION

Those individuals who install, maintain or service elevators are subject to tremendous risk of being trapped or, in a worse case scenario, being crushed by an elevator car while working in a pit of the elevator. When an elevator serviceperson enters the pit of an elevator it is always with the elevator or lift above them. Some elevator pits provide a degree of sanctuary through depth and clearances, often provided by rubber or spring bumpers, however other lifts or elevators may have zero under car clearances. The smallest elevators in public buildings weigh several hundred pounds, whereas commercial freight lifts often weigh several tonnes. Therefore, if any of these elevators or lifts lose control in a downward direction, and if proper safety mechanisms are not in place to provide sanctuary, a person or persons entering or working in the elevator pit could be subjected to serious and potentially fatal injury.

To provide added protection for those elevator service persons working in elevator pits, some industrial locations have made it policy that pipe stands must be temporarily installed in the elevator pit when elevator equipment is being serviced. The difficulties with using pipe stands are that the pipe is often stored away from the elevator, and in the case of a commercial freight lift, can weigh several hundred pounds in order to provide sufficient protection to the worker. These factors can make it difficult or impossible for a single person to service an elevator. In addition, when a pipe stand is being assembled in the elevator pit there is a period of time where the worker is unprotected from elevators that lose control in the down direction.

The concept of preventing uncontrolled movement of an elevator or lift by safety catches is well known in the art. Canadian Patent No. 2,176,911 describes safety arms that are deployed from an elevator to the hoistway or elevator shaft wall to prevent vertical movement of the elevator. U.S. Pat. No. 5,810,118 discloses a hydraulic clamping device that prevents an elevator from slipping during loading and unloading. U.S. Pat. No. 642,448 discloses safety catches that are deployed only when the elevating cables are broken. Although these devices prevent vertical movement of an elevator, they all require significant modification to the elevator, hoistway or both and fail to describe devices that provide sanctuary in the pit of an elevator to allow a serviceperson to work safely.

U.S. Pat. No. 406,630 describes safety catches for elevators that prevent downward movement of the elevator past a predetermined height. These safety catches can be positioned anywhere in the hoistway and prevent the elevator from travelling below a certain predetermined height, which in turn could interfere with normal operation of the elevator or lift.

U.S. Pat. Nos. 5,806,633 and continuation 6,138,798 disclose a safety system that includes a pressure sensor located on the pit floor below the elevator to detect the presence of a person on the pit floor. When a person is detected, actuators are electronically activated to pivot safety columns which are affixed to the pit floor and attach to the rail stop members that are attached to the elevator frame, thereby preventing downward vertical movement of the car below the stop members. This system is specifically designed to provide a false pit for service persons to work safely in the pit of an elevator. However, the fact that the safety device is only activated once a person is in the elevator pit allows for there to be a period of time when the person is unprotected from an elevator moving downward. Moreover, the safety system requires significant modification to the elevator and hoistway, which would result in increased cost, and this system is also subject to failure because of the use of sensors and electronics.

In order to overcome the disadvantages of the prior art, the present invention provides an elevator safety device that is maintained in the hoistway and is manually deployed when service is required in the elevator pit.

### SUMMARY OF THE INVENTION

According to an aspect of the present invention, there is provided a safety device for use in a vertical transportation shaft, the device comprising a shoring means having a lower end and an upper end, mounting means for connecting the shoring means to a substantially vertical side surface of the vertical transportation shaft and operative to move the shoring means between a first position, in which the shoring means is disposed substantially vertical in vicinity of the vertical side surface and a second position in which the shoring means is disposed substantially vertically and spaced from the side vertical surface with the lower end in substantial contact with a floor of the vertical transportation shaft.

The vertical transportation shaft is typically an elevator shaft or hoistway for lifts, dumbwaiters and the like.

The shoring means comprises an elongated vertical structure. Typically the shoring means is an elongated vertical surface of a length that provides a sanctuary with a minimum height slightly above the lowest landing sill when deployed. Preferably, the shoring means will be provided at a height sufficient to protect a serviceperson from being crushed between the lower landing sill and the underside of the elevator car.

The shoring means will commonly be made of steel, although any material with high compressive strength, such as concrete, titanium carbon-fibre, stainless steel, or alloys, such as aluminum alloys or titanium alloys may be suitable. Preferably, the shoring means will be a hollow cylinder, although any hollow or solid shape will be suitable. Alternatively, when the shoring means is provided as a hollow structure the ultimate strength of the shoring means may be increased by filling the structure with fibreglass or the like. The size, shape, material and composition of the shoring means will be determined based on the size and weight of the elevator or lift.

The mounting means comprises a plurality of links which connect the substantially vertical side surface of the elevator pit to a different part of the shoring means along its length. Typically, the links, at a minimum, are 9 inches in length to allow for use as a ladder for access into the elevator pit. Preferably, the links will be at least 12 inches in length. However, the length of the links will be determined by the distance between the substantially vertical surface and the elevator car or other considerations. The links of the mounting means will be of sufficient length to position the shoring means under the elevator car. In most cases the plurality of links will be of equal length, however, in other considerations the links may be of different lengths to allow for the shoring means to be substantially vertical when in the second position and inclined in the first position. Moreover, in most cases, two links between the substantially vertical side surface and the shoring means in vertical relationship to each other will form 4-bar linkage. This 4-bar linkage can be provided as 4-bar parallelogram linkage when the side surface is substantially vertical, but can also be provided as 4-bar trapezoidal linkage to accommodate an inclined side surface.

The mounting means can be made of the same or a different material from the shoring means, as long as they are of sufficient strength to allow a person to use the links as a ladder and to be able to lift the shoring means from the second to first position. In addition, collapsible or telescopic links may be provided to operatively move the shoring means from the first to second position in a horizontal plane.

The safety device of the present invention in the context of an elevator pit safety device, when not in use, exists in the first position which is disposed substantially vertically in the vicinity of a substantially vertical side surface of the pit. When access to the elevator pit is required, the safety device is deployed into a second position in which the shoring means is disposed substantially vertically and spaced from the substantially vertical surface. The substantially vertical surface in this situation refers to the hoistway wall or elevator shaft wall.

According to a further aspect of the present invention there is provided a shock absorbing plate with a collar attached to the underside of the elevator car, which is substantially in vertical alignment with the shoring means when in the second position. The shock absorbing plate provides reinforcement to the underside of the elevator to prevent the elevator from becoming impaled by the shoring means upon impact. The collar is sized and disposed on the shock absorbing plate to receive the shoring means in the second position upon impact. Any material with a high tensile, compressive, bending and flexural strength will be suitable for use as the shock absorbing plate, as long as it will be able to withstand impact with the shoring means. The collar is made of the same or different material as the metal plate and provides a means for preventing horizontal displacement of the elevator when contact is made between the elevator and the shoring means.

Typically, the shoring means is also connected in series with a pit stop switch circuit which is provided in the elevator. The stop circuit is present in all elevators as a safety mechanism that allows the serviceperson to prevent elevator movement. A disconnect is wired into the pit stop switch circuit during normal operation of the elevator to complete the stop circuit. When a serviceperson enters the hoistway through the lowest landing elevator opening he or she turns the stop switch off which opens the stop circuit and renders the elevator inoperable. According to the present invention, the disconnect is physically attached to the shoring means via a connection means, such that the disconnect has to be removed before the safety device is deployed.

According to further embodiments of the present invention, a safety device housing is provided to allow for easy installation of the unit and to minimize potentially fatal installation errors. The safety device housing is adapted to be connected to the substantially vertical side surface and can receive the mounting means either prior to installation or following installation of the housing to the substantially vertical side surface.

The safety device further comprises one or more energy absorbers which can be provided to counteract the force of gravity when moving the shoring means between a first position and a second position. The energy absorbers can be directly connected to the substantially vertical side surface or can be indirectly connected to the substantially vertical side surface by being connected to the housing. Typically, the energy absorbers are either gas or hydraulic absorbers.

Furthermore, a bumper made of rubber or the like may be disposed on the lower end of the shoring means to prevent injury to the serviceperson or damage to the elevator pit floor. Shock absorbers may also be provided in conjunction with the bumper to help absorb the energy transfer of any impact between the elevator car and the shoring means.

In addition, contained within the safety device housing or separate from the housing there is provided a latching means that engages the shoring means, when disposed in the first position, to prevent accidental deployment from the first position during normal operation of the elevator.

The safety device of the present invention further comprises a handle associated with the shoring means. The handle can be mounted on the shoring means or can be provided as an extension to one or more of the links. The handle allows for the user to be able to move the safety device between the first and second positions.

### BRIEF DESCRIPTION OF THE DRAWINGS

FIG. 1 is a side view of an elevator pit safety device of the present invention in the second position;

FIG. 2 is a top view of the elevator pit safety device shown in FIG. 1;

FIG. 3 shows a perspective view of the elevator pit safety device shown in FIGS. 1 and 2;

FIG. 4 is a side view of an embodiment of the elevator pit safety device of the present invention in the first position;

FIG. 5 is a top view of the elevator pit safety device shown in FIG. 4;

FIG. 6 is a perspective view of the elevator pit safety device shown in FIGS. 4 and 5; and

FIG. 7 provides a perspective view of a further embodiment of the elevator pit safety device of the present invention in the second position.

### DETAILED DESCRIPTION OF THE INVENTION

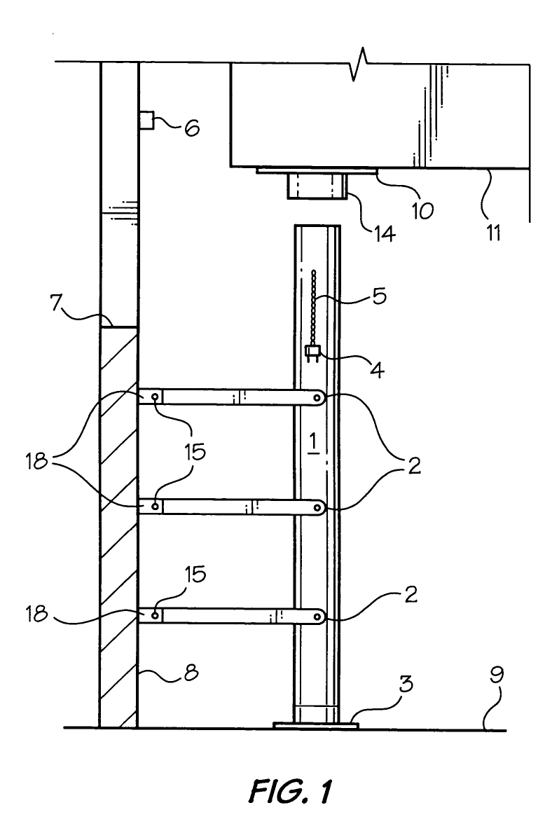

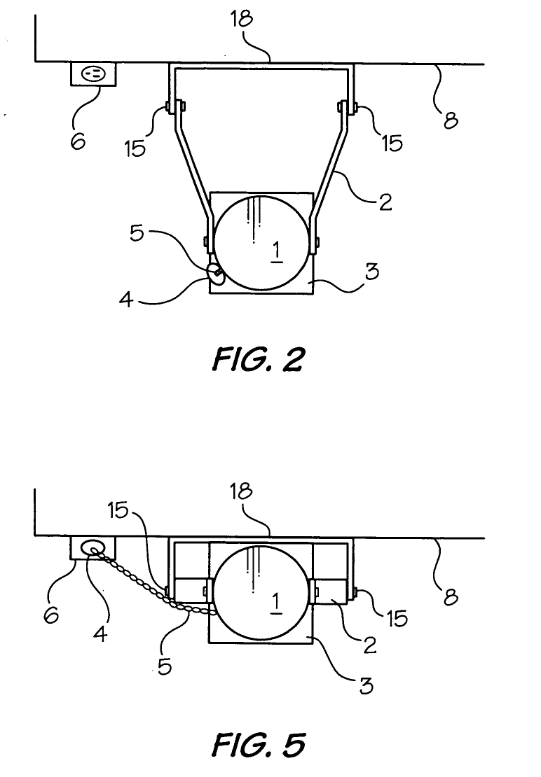

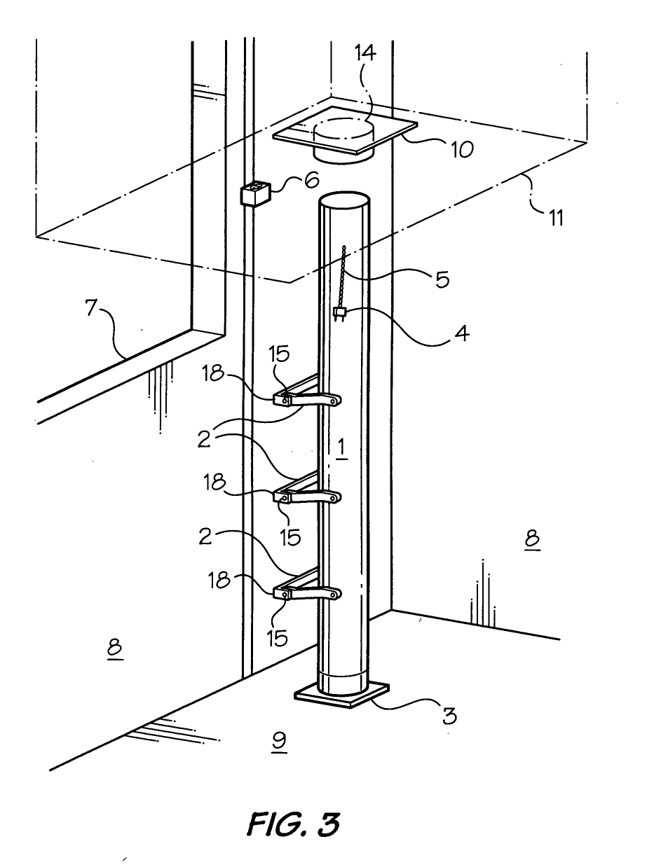

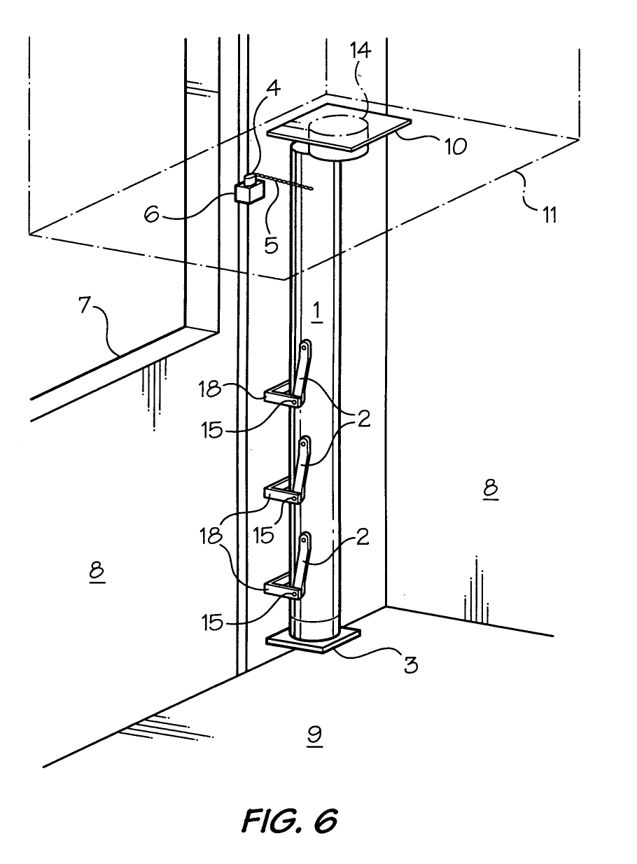

Although other applications may be envisioned for the safety device of the present invention, such as a safety device for a situation that requires work to be conducted under an object, the use of a safety device of the present invention is particularly advantageous in installation, maintenance and service of elevators or lifts. Accordingly, without intending to limit the present invention to the embodiments described herein, the invention will be described below in further detail having regard to the elevator pit safety devices shown in FIGS. 1 to 7.

FIGS. 1 to 3 show a safety device according to an embodiment of the present invention. The safety device comprises a shoring means 1 attached to a substantially vertical surface 8 via mounting means 18. When a serviceperson is required to enter a hoistway, he or she removes a disconnect 4, which is physically connected to the shoring means 1 by a connection means 5, from a stop switch circuit 6 and deploys the shoring means 1 to the elevator pit floor 9 by pushing on shoring means 1, which through 4-bar linkage, moves the mounting means 18 from a first position to a second position. When the shoring means 1 is deployed to the second position, links 2 of the mounting means 18 can be used as a ladder for access from an elevator opening 7 to the elevator pit floor 9. On the lower end of the shoring means 1, which contacts the elevator pit floor 9, there is a bumper 3 that will assist in absorbing any impact between the elevator 11 and the shoring means 1. In addition, the bumper 3 will protect a serviceperson from accidentally lowering the shoring means 1 onto their foot.

To prevent the shoring means 1 from impaling the elevator 11 upon impact, there is provided a shock absorbing plate 10, which is located directly above the shoring means 1 when the shoring means 1 is deployed in the second position and is in contact with the elevator pit floor 9. The shock absorbing plate 10 is of sufficient size to disperse the energy from any impact between the shoring means 1 and the elevator 11 over the underside of the elevator 11 and prevent direct penetration of the shoring means 1 through the elevator 11. Furthermore, a collar 14 is provided between the shock absorbing plate 10 and the shoring means 1 to prevent horizontal displacement of the elevator 11 and the shoring means 1. The collar 14 is slightly wider in diameter than the shoring means 1 and is aligned substantially vertically above the shoring means 1 when in the second position.

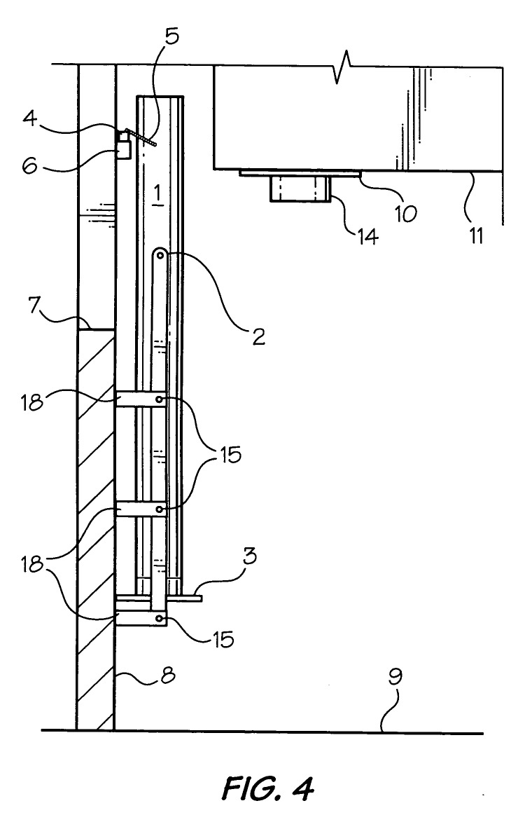

FIGS. 4 to 6 show a safety device according to an embodiment of the present invention. During normal operation of an elevator 11 the safety device exists in the first position, which is disposed substantially vertically in a vicinity of the substantially vertical surface 8, so that the elevator 11 can travel vertically without being interfered by the safety device. When the safety device is in the first position, the mounting means 18 are rotated vertically about pivot points 15. To resume normal operation of the elevator 11, a disconnect 4 is plugged back into stop switch 6 thus closing the stop circuit.

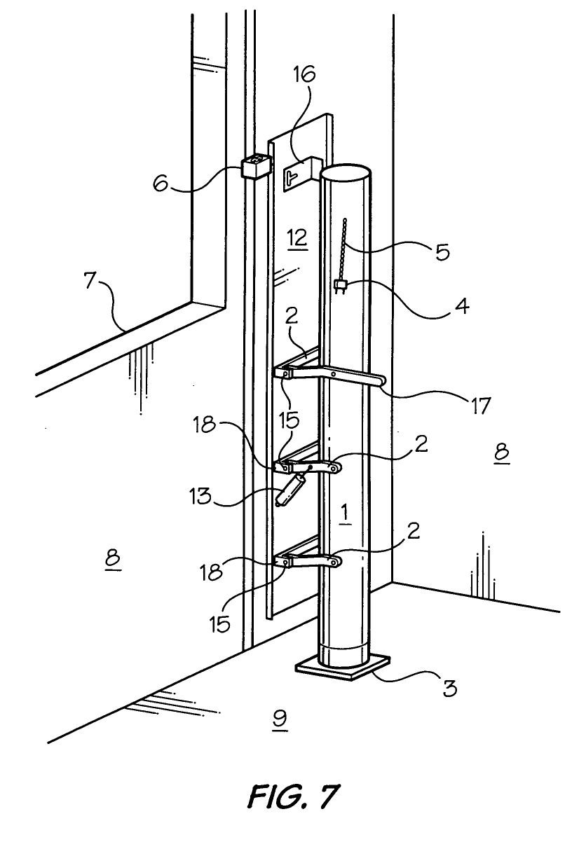

FIG. 7 shows a further embodiment of the present invention. In this embodiment there is provided a safety device housing 12, which allows for the elevator safety device to be assembled off-site and installed as one unit following a template for attaching the safety device housing 12 to the substantially vertical surface 8. Furthermore, there is provided one or more energy absorbers 13 attached to the links 2 and the safety device housing 12. These energy absorbers 13 counteract the force of gravity when a serviceperson deploys or retracts the shoring means 1 between the first and second positions. Latching means 16 are also provided which retain the shoring means 1 in the first position, in which the shoring means 1 is disposed substantially vertically in a vicinity of the substantially vertical surface 8. The latching means 16 prevents accidental deployment of the safety device to the second position during normal operation of the elevator 11. Alternatively, the link 2 closest to the elevator opening 7 may be provided with a handle extension 17 to assist in operating the safety device from the first and second position.

The safety device of the present invention provides an economical and easy to use alternative for providing service personnel sanctuary while working in an elevator pit with an elevator car overhead. Compared to other safety devices already known in the art, the present invention requires minimal installation on the elevator itself, allows a serviceperson to be protected before entering an elevator pit, does not rely on electronics or other devices that could fail and is cost-effective to manufacture and install.

I claim:

1. A safety device for use in a vertical transportation shaft, the device comprising a shoring means capable of vertical orientation and having a lower end and an upper end, and mounting means for connecting the shoring means to a substantially vertical side surface of said vertical transportation shaft and operative to move said shoring means between a first position, in which the shoring means is disposed substantially vertically in vicinity of said vertical side surface and a second position in which the shoring means is disposed substantially vertically and spaced,from said vertical side surface with said lower end in substantial contact with a floor of said vertical transportation shaft.

2. The safety device according to claim 1, wherein said shoring means comprises an elongated vertical structure.

3. The safety device according to claim 1, wherein said mounting means comprises a plurality of links, each of said links connecting said vertical side surface to a different point of said shoring means along its length.

4. The safety device according to claim 3, wherein two of said links between said vertical side surface and said shoring means provide 4-bar linkage.

5. The safety device according to claim 4, wherein said 4-bar linkage is either a parallelogram or trapezoidal linkage.

6. The safety device according to claim 1, wherein said substantially vertical side surface is a hoistway or elevator shaft wall.

7. The safety device according to claim 1, wherein a bumper or shock absorber is disposed on the lower end of the shoring means.

8. The safety device according to claim 1, wherein a shock absorbing plate is disposed on a bottom surface of an elevator car between the elevator car and the shoring means in the second position.

9. The safety device according to claim 8, wherein a collar is associated with the shock absorbing plate and is sized and disposed to receive the upper end of said shoring means in said second position.

10. The safety device according to claim 9, wherein said collar provides horizontal stability to said elevator car when it is supported by said shoring means.

11. The safety device according to claim 1, wherein the vertical transportation shaft is a hoistway or elevator shaft.

12. The safety device according to claim 1, further comprising a disconnect which is connected to the shoring means by a connection means.

13. The safety device according to claim 12, wherein said disconnect is wired into a stop switch circuit when said safety device is disposed in said first position.

14. The safety device according to claim 12, wherein said disconnect is detached from a stop switch circuit when said safety device is disposed in said second position.

15. The safety device according to claim 1, further comprising a latching means which is connected to said substantially vertical side surface, said latching means being disposed to engage said shoring means when said safety device is disposed in said first position.

16. The safety device according to claim 15, wherein said latching means engages said shoring means to prevent accidental deployment from said first position.

17. The safety device according to claim 1, further comprising one or more energy absorbers connected to said substantially vertical side surface at one end and associated with said shoring means at another end.

18. The safety device according to claim 1, further comprising a handle associated with said shoring means and operable to move said shoring means between said first and second positions.

19. The safety device according to claim 1, further comprising a housing connected to said substantially vertical side surface, said housing adapted to receive said mounting means.
